(19) United States
(12) Patent Application Publication
(10) Pub. No.: US 2009/0097735 A1
(43) Pub. Date: Apr. 16, 2009

(54) SAMPLE INSPECTION, MEASURING METHOD AND CHARGED PARTICLE BEAM APPARATUS

(76) Inventor: Fumihiro SASAJIMA, Hitachinaka (JP)

Correspondence Address: MCDERMOTT WILL & EMERY LLP, 600 13TH STREET, N.W., WASHINGTON, DC, 20005-3096, US

(21) Appl. No.: 12/239,015

(22) Filed: Sep. 26, 2008

(30) Foreign Application Priority Data
Sep. 27, 2007 (JP) 2007-250400

(51) Int. Cl. G06K 9/00

(52) U.S. Cl. 382/141

(57) ABSTRACT

An image for measuring a pattern or an image for making positioning for measurement is formed by scanning a sample with a focused electron beam and an estimation value of the image is compared with an image estimation value of a previously gotten reference image, so that focusing of the electron beam is performed again when it is judged that the formed image does not satisfy a predetermined condition by the comparison with the reference image.

### BACKGROUND OF THE INVENTION

The present invention relates to a sample inspection, measuring method and a scanning electron microscope and more particularly to an inspection, measuring method of performing focusing before inspection or measurement and a scanning electron microscope.

Recently, with high density integration and minuteness of semiconductor elements, the technique of inspecting or measuring minute pattern exactly at high speed is important. However, inspection or measurement is performed in the processing procedure that the image processing technique is used to perform positioning with magnification of some steps at a present situation due to the minuteness of pattern and the performance limit of hardware of an inspection, measuring apparatus such as a scanning electron microscope and finally get an image in a state focused at a correct position with measurement magnification.

JP-A-11-251224 (corresponding to U.S. Pat. No. 6,363,167) discloses an example that pattern matching using a template is performed after automatic focusing and a pattern is then measured. Generally, the automatic focusing is performed so that an objective lens is used to change the focus at regular intervals while getting an image or signal information at this time and the focus at the time that the variation amount or edge amount is maximized is judged as “focused”, so that the position at this time is judged to be a focal position.

Moreover, the focused image is used to perform positioning. In a general method thereof, reference image or design information is previously registered to calculate a correlation value between it and an actual image, so that the position where the correlation value is maximum is judged to be the “position to be detected” and positioning is performed to the position.

Finally, an object to be inspected or measured contained in the place or part to which the positioning has been performed or another part specified therefrom is inspected or measured.

By performing the automatic focusing, an electron beam of an electron microscope is focused, although even if such an electron beam is used to get an image for positioning or measurement, the image is sometimes disturbed due to the following reasons.

First, during the period until the image used for measurement is obtained after automatic focussing or while the image is being obtained, the picture quality thereof is sometimes disturbed due to external factor. As an example, surroundings around an installation place of the apparatus sometimes constitute the external factor. For example, the body of the electron microscope is placed near an elevator and the elevator is operated irregularly, so that sudden vibration or disturbance of magnetic field sometimes occurs. Furthermore, there is a possibility that unexpected vibration occurs when a weighty object is carried near the apparatus.

In addition, when the pattern used for automatic focussing is different from a pattern to be measured or a pattern for positioning, focusing is not sometimes made on the pattern to be measured when there is difference in height therebetween. Factors of the difference in height contain unbalance in height occurring due to imperfection in adjustment of the apparatus or unbalance in height based on a problem of a sample itself.

There is a possibility that defocusing occurs due to the above factors when the image used for measurement is obtained and measurement accuracy and positioning accuracy are influenced. When automatic measurement is performed, there is a possibility that the operator merely understands the fact that the measurement accuracy is reduced from the final result, so that the automatic measurement rate of the apparatus is reduced.

In JP-A-11-251224, it is merely described that when the pattern does not satisfy the predetermined standard, the measurement of the pattern is skipped, so that it is impossible to perform the measurement when there is any factor of reduction in accuracy.

Moreover, even granted that correct focus information is obtained by the focusing, the focus is sometimes deviated due to external vibration or magnetic field received when movement is made to an actual measurement position after the focusing has been completed or due to difference in height between the focusing position and the inspection and measurement position when the position for performing focusing is different from the inspection and measurement position in order to minimize damage to an actual measurement pattern.

Further, even if focusing is made on the surface of the inspection or measurement position when the height or depth of the pattern is large, there is a case where focusing is not made on the bottom thereof. In such a case, there is a possibility that defocusing occurs on an image to be measured actually or part to be inspected or measured and correct inspection and measurement cannot be performed.

### SUMMARY OF THE INVENTION

A sample inspection, measuring method in which measurement can be made on the basis of a high picture quality image subjected to adjustment such as focusing notwithstanding influence of external disturbance and the like and a scanning electron microscope are now described.

In order to achieve the above object, according to an aspect of the present invention, there is provided a sample inspection, measuring method or apparatus of performing inspection or measurement of a pattern on a sample on the basis of electrons gotten by scanning the sample with a focused electron beam, wherein an image for measuring the pattern or an image for making positioning for the measurement is formed by scanning the sample with the focused electron beam and an estimation value of the image is compared with an image estimation value of a previously gotten reference image, so that when it is judged that the formed image does not satisfy a predetermined condition by the comparison with the reference image, focusing of the electron beam is performed again.

As described above, the image estimation value of the previously gotten measurement image or the image for positioning is compared with the estimation value of the actually gotten image to judge whether the gotten image is proper or not, so that even if the image becomes an improper image for measurement due to external disturbance, the image can be subjected to proper processing to use it for measurement or positioning. Moreover, when it is judged to be proper for measurement, measurement can be performed without focusing, so that the throughput can be improved.

According to the above aspect, since focusing is performed selectively when it is judged that it is not proper to perform measurement due to influence of external disturbance, the high accuracy measurement and the high throughput of the apparatus are compatible.

Furthermore, the defocusing information is gotten in a plurality of wafers to be processed statistically and defocusing always occurring on a condition such as a specific position due to structure of hardware is discriminated from defocusing occurring due to other causes except it, so that the user is warned not to perform measurement or positioning at that position with regard to defocusing caused by the structure of hardware, so that the operation efficiency can be improved.

Other objects, features and advantages of the invention will become apparent from the following description of the embodiments of the invention taken in conjunction with the accompanying drawings.

### BRIEF DESCRIPTION OF THE DRAWINGS

FIG. 1 is a flow chart showing an example of positioning;

FIG. 2 is a flow chart showing an example of positioning proposed by the present invention;

FIG. 3 is a flow chart showing general automatic inspection;

FIG. 4 shows an example of an image estimation value setting picture;

FIG. 5 shows an example of a detailed image estimation value setting picture;

FIG. 6 shows an example (1) of a method of displaying calculated results of the image estimation values;

FIG. 7 shows an example (2) of the method of displaying calculated results of the image estimation values;

FIG. 8 is a schematic diagram illustrating a scanning electron microscope;

FIG. 9 is a flow chart showing processing in case where an image is estimated before and after measurement;

FIGS. 10A, 10B and 10C show examples using selection region of an image for judgment of the picture quality;

FIG. 11 is a diagram for explaining the state that the height of a pattern is larger than a focal depth of the apparatus;

FIGS. 12A, 12B, 12C and 12D show types of the range in which an image is estimated;

FIG. 13 is a diagram for explaining an example of a method of discriminating between variation in process and defocusing by using peripheral length information of pattern;

FIGS. 14A to 14E are diagrams for explaining examples in which image estimation is applied to a plurality of patterns existing in an image;

FIG. 15 is a diagram for explaining an example for estimating an image in which line pattern is displayed;

FIG. 16 shows an example for detecting local defocusing by statistically using information of a plurality of chips in a wafer;

FIGS. 17A, 17B and 17C show examples for displaying a plurality of pieces of information containing picture quality estimation information in a wafer map manner;

FIGS. 18A and 18B are diagrams for explaining the principle of mis-measurement caused by defocusing;

FIG. 19 shows a display example of a wafer map;

FIG. 20 shows a display example of a wafer map;

FIG. 21 shows a display example of a wafer map; and

FIG. 22 shows a display example of a wafer map.

### DESCRIPTION OF THE EMBODIMENTS

### Embodiment 1

In positioning to an inspection or measurement position using a scanning electron microscope, for example, characteristic patterns (reference images) in magnifications and positions set at several steps and the positions thereof are stored to make them subjected to pattern matching with an actual inspection image, so that its position is detected automatically and a position of a finally measured minute pattern is detected. Moreover, in order to prevent deterioration in the picture quality due to change in height of a wafer, automatic or manual focusing of the pattern is also performed.

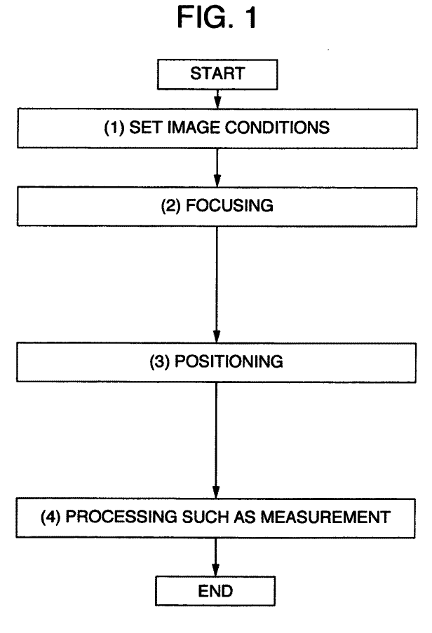

A general sequential operation for making positioning/measurement at each step is now described with reference to FIG. 1. First, image conditions are set (1). In this step, conditions such as magnification for making positioning/measurement are set. (Image getting conditions such as magnification are set.)

Next, focusing (2) is performed. In this step, setting of conditions such as magnification for making focusing if necessary and movement to position are performed. Then, focusing is performed. In general processing for performing focusing, a focus is changed or shifted at regular intervals and an image or signal information at each time is gotten, so that a focus at the time that an variation amount or edge amount is maximized is judged as “focused” and the position at this time is set to be a focal position.

(Movement is made to a position where focusing is performed. A focus on an image is shifted at regular intervals and an image or signal information at each time is gotten, so that an image at the time that an variation amount or edge amount is maximized is judged to be “a focused image” and conditions at this time are stored. Movement is made to a position used for positioning/measurement and an image is gotten on the image conditions calculated above.)

Then, positioning (3) is performed. In a general method thereof, reference image or design information is previously set to calculate the correlation between it and an actual image, so that the position where the correlation is maximized is judged to be “position to be detected” and positioning is performed to the position.

(Movement is made to a position where positioning is performed. When positioning is performed automatically, reference image is stored and the reference image is used to perform positioning to the position where the correlation is maximum. When positioning is performed manually, user designates a position manually.)

Finally, processing (4) such as measurement and preservation of image is performed. In the sequential operation in which measurement or other inspection is performed finally, measurement or other inspection is performed.

However, a problem sometimes arises in the finally gotten image due to the following problems. First, during the period until the image used for focusing is obtained after the focusing is performed or while the image is being obtained, the picture quality thereof is disturbed due to external factor. Moreover, when the pattern at the time that focusing is performed is different from the pattern used for measurement and positioning, there is considered the case where it is impossible to be focused on the pattern used for actual positioning due to difference in height thereof.

The external factor occurs due to surroundings around an installation place of the apparatus, for example. An elevator is installed near the apparatus and operated irregularly, so that sudden vibration or disturbance of magnetic field occurs. Moreover, there is a possibility that unexpected vibration occurs even when a weighty object is carried near the apparatus.

The above-mentioned difference in height between the measurement pattern and the focusing pattern occurs due to unbalance in height occurring due to imperfection in adjustment of the apparatus or unbalance in height of a wafer itself, for example. There is a case that defocusing occurs in the image used for actual positioning and measurement and the measurement accuracy is reduced. As a result, there is a problem that the reliability of automatic measurement is reduced.

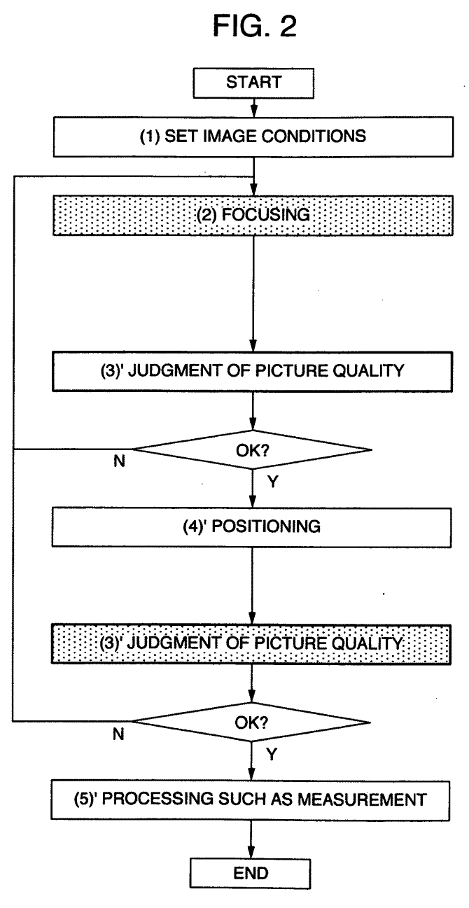

In order to solve such problems, during the period between the focusing of the image and the acquisition of the image used for positioning or measurement or as pre-processing of positioning or measurement when focusing is not performed, judgment as to whether the image is an actually focused image or not or whether the image can be used for positioning or measurement or not is made and when the image does not satisfy the standard thereof, the focusing is performed again (FIG. 2-(3)′).

In the image estimation processing (FIG. 2-(3)′) proposed below, values for estimating the image such as S/N value and edge amount of an obtained image are used. These estimation values are compared with a reference image used in positioning and measurement. In the embodiment, the ratio of both of them is calculated and when the ratio does not reach a predetermined value, focusing is performed again. In the embodiment, two images are compared on the basis of the ratio of both of them, although comparison based on the image estimation processing proposed generally is applicable. The image estimation processing can be performed even when the focusing is not performed, for example. Furthermore, some or all of the judgments can be set as the standard of judgment.

The image estimation processing can be basically applied to all steps of the processing for obtaining the image, although the processing may be performed in the step deemed to be specifically important from the processing time and the convenience that the user can set the propriety of application thereof in a graphical user interface (GUI). In FIG. 2, the image estimation processing is applied just before processing such as positioning and measurement. According to the above configuration, the image having low picture quality can be detected before positioning or measurement is performed.

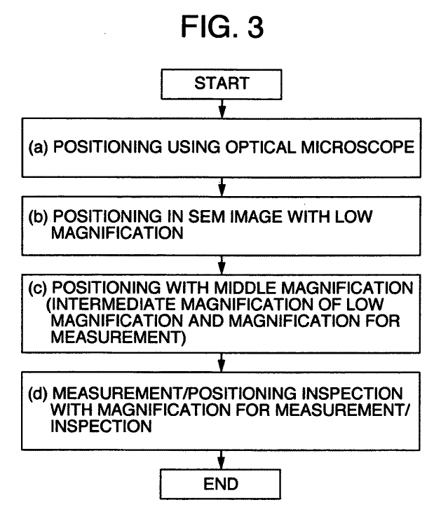

The embodiment is now described with reference to the accompanying drawings. FIG. 3 is a flow chart showing general automatic measurement/inspection processing. Positioning is performed with a plurality of magnifications in consideration of the positional accuracy of the apparatus and scattered quality caused by the manufacturing process of a wafer to be measured and is continued until magnification for final measurement/inspection is reached. The processing is performed according to the following procedure.

First, an optical microscope, a metal microscope or the like is used to get an image with the magnification of about 100 to 500 so as to perform positioning. Next, positioning is performed using an image gotten with low magnification. At this time, a scanning electron microscope (hereinafter abbreviated to SEM) is used to perform the processing with magnification of about 1000 to 20000. Thereafter, the positioning is performed with middle magnification if necessary and finally the positioning is performed with magnification for performing measurement or other inspection, so that a position of a pattern to be measured/inspected is detected to get an image or signal having the picture quality endurable to measurement/inspection. The above processing is repeatedly performed in a plurality of points within a wafer to be measured.

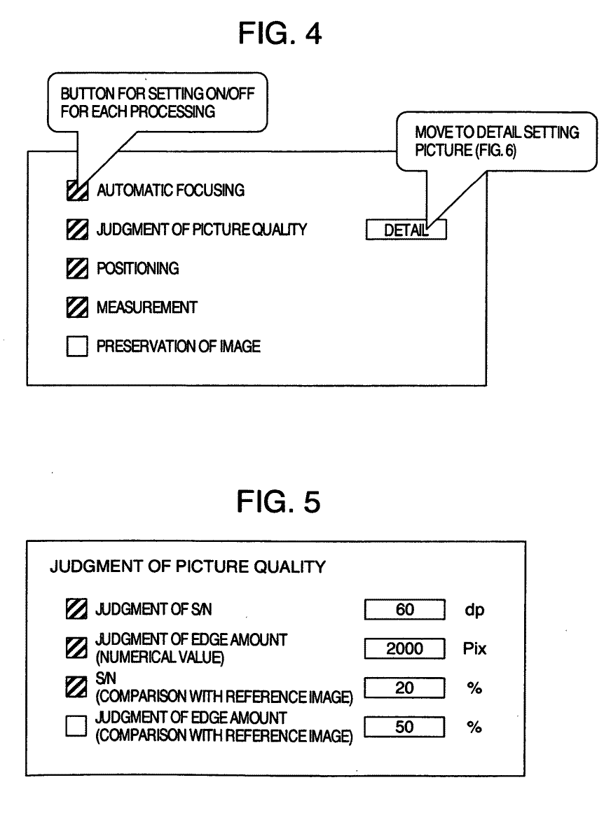

The image estimation processing is performed in each step of the above processing. Setting for image estimation can be made in a graphical user interface (hereinafter abbreviated to GUI) as shown in FIGS. 4 and 5.

FIG. 4 shows an example of a picture for setting. There are provided buttons for setting ON/OFF for each processing. When processing is not selected, the button corresponding to the processing is displayed in the color similar to that of the picture and when the processing is selected, the button corresponding to the processing is displayed in yellow or green so as to show that the button is selected. Furthermore, there is a button for movement to a detail window for each item if necessary. When this button is clicked, the picture moves to the detail setting picture.

FIG. 5 shows an example of the detail setting picture. In the detail setting picture, image estimation systems are enumerated and selection information of ON/OFF buttons provided for respective items and threshold values can be inputted. When a numerical value of estimation of an inspection image is smaller than the threshold value set in the picture, it is judged to be an error and error information is issued to move to the state that movement is made to processing for a next measurement point or the state that processing for the second time is performed automatically or the state that processing is stopped at that state and user's measures are demanded.

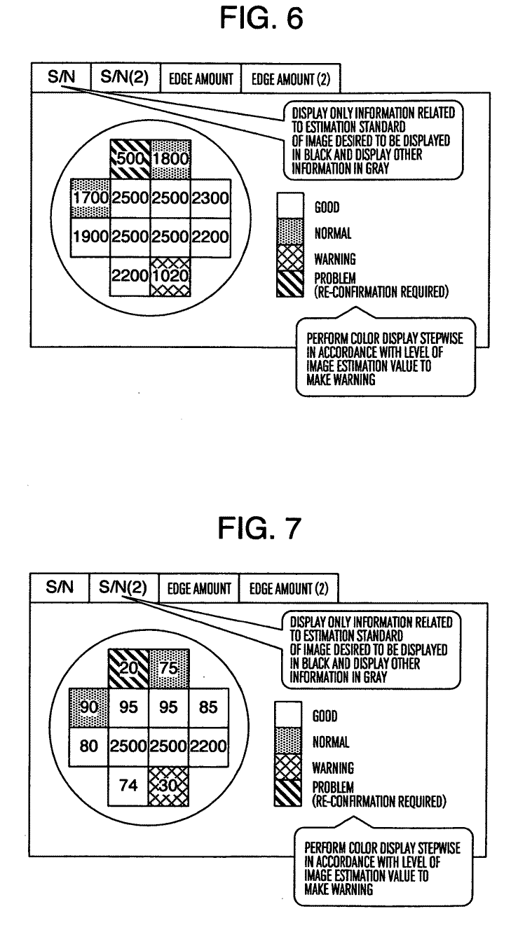

As shown in FIGS. 6 and 7, the above information is statistically processed with regard to an object to be measured such as wafer and is displayed in a GUI manner. Numerical values of image estimation results are displayed in colors and when the value is small, it is displayed by a warning color such as red. According to this function, a tendency in the wafer can be grasped.

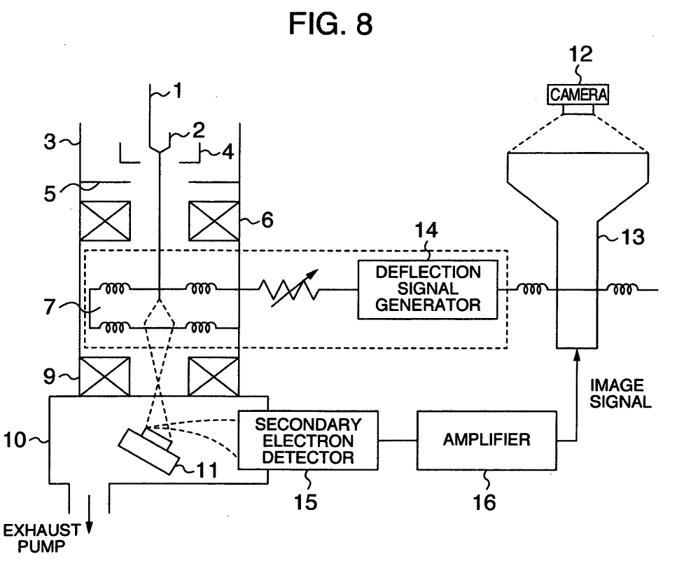

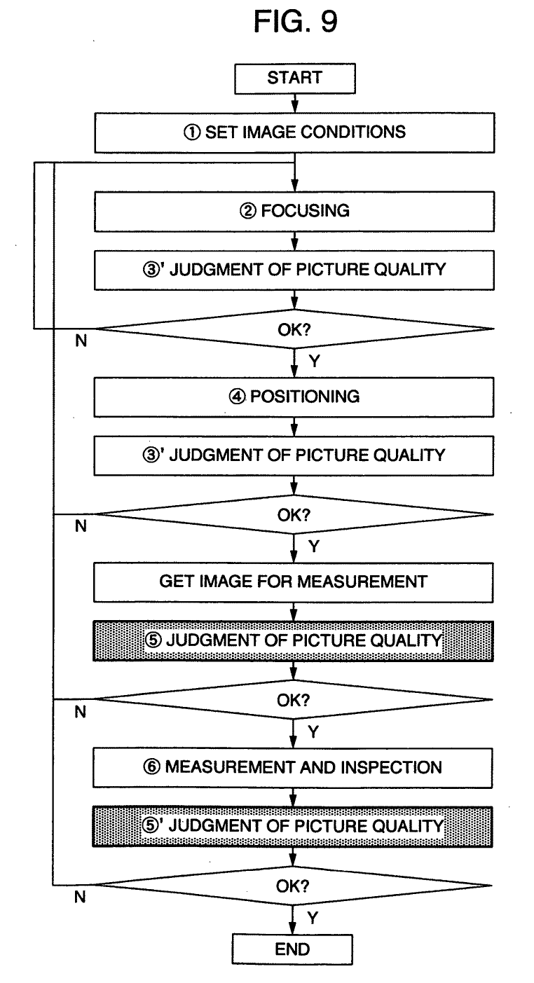

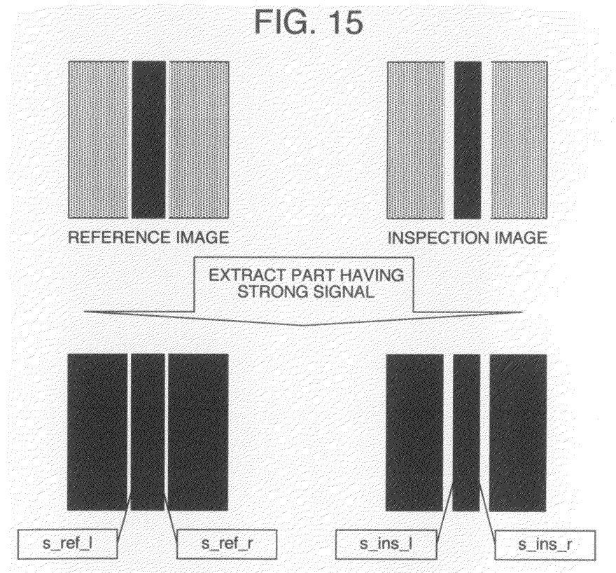

FIG. 8 is a schematic diagram illustrating a scanning electron microscope. The scanning electron microscope described here is controlled by a controller not shown and the controller controls devices on the basis of processing procedures as shown in FIGS. 1 to 3. Furthermore, the controller includes a storage medium for storing programs which display GUI as shown in FIGS. 4 to 7 in a display unit 14. A program which executes the processing procedures shown in FIGS. 1 to 3 on the basis of conditions set in the GUI is also stored. Moreover, processing procedures illustrated in FIGS. 9 to 22 or a program for displaying a wafer map may be stored. In the embodiment, the scanning electron microscope which is an example of a charged particle beam apparatus is described by way of example, although the present invention is not limited thereto and the present invention can be also applied to, for example, a focused ion beam apparatus which forms an image on the basis of secondary particles (electrons and ions) obtained by making scanning by ion beam and other charged particle beam apparatuses. In the embodiment, an example using an objective lens of magnetic field type is described as a construction for adjusting a focus of a beam, although the present invention is not limited thereto and an objective lens of electrostatic type or a superposed lens formed by superposition of magnetic field and electrostatic types, for example, can be applied. The electrostatic lens may be formed by the technique (retarding technique) that a negative voltage is applied to a sample to accelerate the electron beam reaching the sample at low speed.

Moreover, the controller may be a dedicated computer for controlling a mirror body of the scanning electron microscope or an external computer for making transmission and reception of data through various communication media.

An electron gun 1 in a mirror body 3 of the scanning electron microscope energizes a heating filament 2 to heat it and produces an electron beam 8. The electron beam 8 derived by a weneld 4 is accelerated by an anode 5 and focused by a condenser lens 6. Then, the focused electron beam 8 is scanned by a deflection coil 7 to which a deflection signal is applied from a deflection signal generator 14 and focused on a sample 11 put in a sample room 10 by an objective lens 9.

Thus, the electron beam 8 one-dimensionally or two-dimensionally scans the sample 11 in which minute pattern is formed. When the sample 11 is irradiated with the electron beam 8, secondary electrons having an amount corresponding to the shape of the surface of the sample 11 are generated from the vicinity of the surface of the sample 11 and detected by a secondary electron detector 15. The detected secondary electrons are amplified by an amplifier 16 to be supplied to a cathode ray tube (CRT) 13 as a brightness modulation signal. The CRT 13 is synchronized with the deflection signal generator 14 and the brightness modulation signal reproduces a secondary electron image generated from the surface of the sample 11 by the electron beam 8 with which the sample 11 is irradiated in synchronism therewith. According to the above-mentioned procedure, information of the minute pattern formed on the surface of the sample can be gotten. The secondary electron image displayed in the CRT 13 is photographed by a camera 12 if necessary.

### Embodiment 2

In the embodiment 1, an example of the method and the apparatus capable of performing measurement and inspection on the basis of the image on which focusing is properly performed notwithstanding external disturbance occurring during the period between focusing and acquisition of image for measurement and inspection has been described, although in the embodiment 2 an example of the method and the apparatus capable of suppressing an error in judgment of picture quality caused by the case where another pattern is disposed adjacent to a pattern to be measured or inspected or a semiconductor process is described.

FIG. 9 is a flow chart showing processing from focusing until measurement and inspection are performed. First, magnification and acquisition conditions of image (optical conditions of SEM, amplification factor of detector, kind and degree of image processing to be applied and the like) are set (step (1)). Next, an irradiation position of electron beam (position to be scanned by electron beam) is moved to a position where focusing on the sample is performed on the basis of the set acquisition conditions. The movement of the irradiation position of electron beam is performed by movement of a sample stage on which the sample is placed or image shift for deflecting the orbit of electron beam or combination of both of them.

After the irradiation position of the electron beam is moved to the position where focusing is performed, focusing is performed (step (2)). In the focusing, the focus of the electron beam is shifted at regular intervals and a focus estimation value for image or signal information gotten by each focus is judged, so that a focal point having a largest estimation value is judged to be a focused position and lens conditions at this time (exciting current for objective lens of magnetic field type, application voltage to electrode constituting electrostatic lens for electrostatic lens and both of them for combination of both lenses) are stored.

At this time, picture quality is judged (step (3)′). When the picture quality judgment result does not satisfy predetermined conditions, the processing is returned to step (2) and the focusing is performed again.

(Movement is made to a position where focusing is performed. The focus on image is shifted at regular intervals and an image or signal information of each step is gotten. A part where a variation amount or an edge amount is maximum is judged to be a “focused image” and conditions at this time is stored. Movement is made to a position used for positioning or measurement and an image is gotten on image conditions calculated above.)

Next, positioning of image is performed (step (4)′). The irradiation position of the electron beam is moved to get an image on conditions that the electron beam is focused on lens conditions gotten in step (2). Moreover, the image is subjected to judgment of picture quality (step (3)′) and when it is judged that the image does not satisfy predetermined conditions, the processing is returned to step (2) and the focusing is performed again.

(Movement is made to a position where positioning is performed. When positioning is performed automatically, reference image is registered and the reference image is used to perform positioning to a position where correlation is maximum. When positioning is performed manually, the user designates a position manually.)

When the image is judged to be proper by the picture quality judgment, an image for measurement is gotten and the image is subjected to the picture quality judgment (step (5)). The picture quality judgment of step (5) can be omitted when the image gotten in positioning is the same as the image for measurement.

If the picture quality judgment result is proper, measurement and inspection are performed (step (6)) and the picture quality judgment is performed again at this time (step (5)′). When this result does not satisfy the predetermined conditions, focusing is performed again so as to be able to get a proper image.

In the flow chart of FIG. 9, after the positioning (step (4)′) and the picture quality judgment subsequent thereto are performed, the image for measurement and inspection is gotten. In this case, it is considered that the following measures are adopted so as to be able to perform the picture quality judgment properly.

For example, when there is another pattern adjacent to the pattern to be measured and inspected and the sufficient positioning accuracy cannot be ensured in the positioning (step (4)′) or when positioning (step (4)′) is not performed in order to preferentially suppress damage of pattern due to irradiation of electron beam in consideration of characteristics of material of pattern to be measured and inspected, an adjacent pattern which does not exist in the reference image for estimation of the picture quality sometimes appears in the image to be subjected to estimation of the picture quality.

(Re-processing from focusing is performed. The position for focusing can be changed from the last position. The user is notified that the picture quality has a problem and movement is made to a next point. Next processing is continued as it is.)

Furthermore, when foreign matter is attached on the sample, the foreign matter is displayed in the image to be measured and inspected, whereas such foreign matter is not displayed in the reference image.

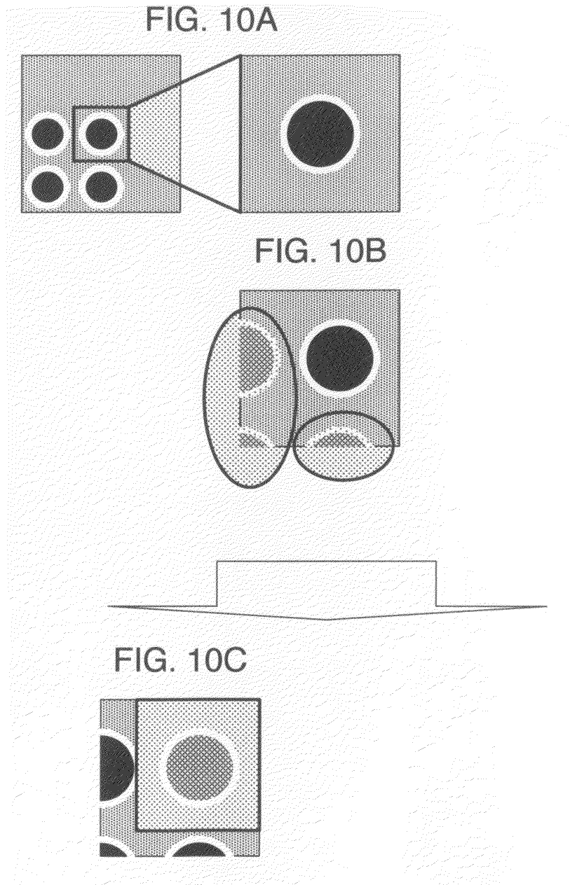

In such circumstances, when the picture quality is judged on the basis of comparison of the reference image and the image to be measured and inspected, different objects are to be compared. Accordingly, an image to be judged to be essentially proper is sometimes judged to be improper whereas an improper image is sometimes judged to be proper. FIGS. 10A, 10B and 10C show examples of images of a sample in which contact holes of the same shape are arranged. When an image in which one contact hole is expressed selectively is defined as the reference image, the case where only the same pattern as the reference image appears in the image to be measured and inspected as shown in FIG. 10A has no problem. However, as shown in FIG. 10B, when a pattern different from the reference image is contained in the image to be measured and inspected, the image to be compared is greatly different from the reference image and accordingly the reliability of judgment of the picture quality using the comparison of images is reduced.

(In FIG. 10B, parts enclosed by circle are patterns which are not contained in the reference image and accordingly the parts exert a bad influence to estimation of image. In FIG. 10C, only an overlapped region in positioning is used for judgment of image.)

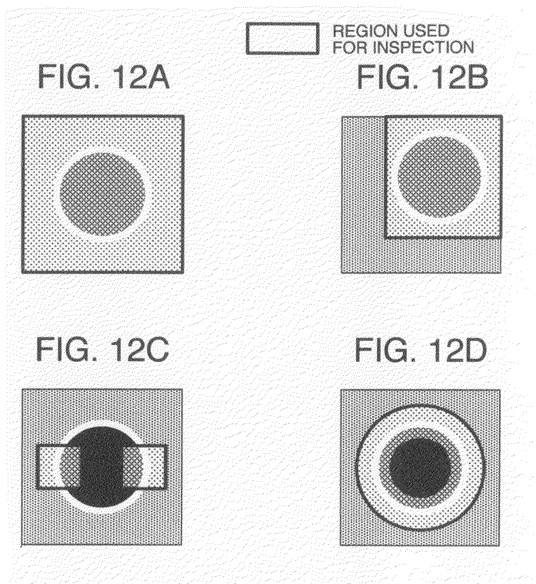

As described above, in order to perform the picture quality judgment properly even if a pattern different from the reference image or foreign matter is mixed or contained in the reference image, in the embodiment, a method using only the region where the reference image and the image to be measured and inspected overlap each other in positioning for the picture quality judgment selectively is proposed (FIG. 12B). In this case, the region overlapping with the reference image is selectively used in the positioning of the preceding step (e.g. step (4)′ of FIG. 9), for example.

As an example of a concrete picture quality estimation method, it is considered that the picture quality judgment is performed except for part where a coincidence degree is smaller than a predetermined value in the relative position of the image to be measured and inspected and the reference image having a highest estimated coincidence degree when a coincidence degree of image is judged.

Moreover, the region used in judgment of image uses, for example, information concerning position and size of template for positioning used when positioning of the reference image and the inspection image is performed. As the information, the whole image of the reference image is used (FIG. 12A) (in FIG. 12A, the whole image is set to an estimation range) or the region containing a characteristic part in the image designated by the user or set automatically as setting for positioning is used (FIG. 12B) (in FIG. 12B, only overlapped region in positioning is used) or information of region (FIGS. 12C and 12D) used for measurement is used (In FIG. 12C, when only a region of interest is set to an inspection region (1), a measurement region for measuring a diameter component in vertical or horizontal direction is used and in FIG. 12D, when only a region of interest is set to an inspection region (2), only a region for measurement in a radial direction such as contact hole is used) depending on the positioning system.

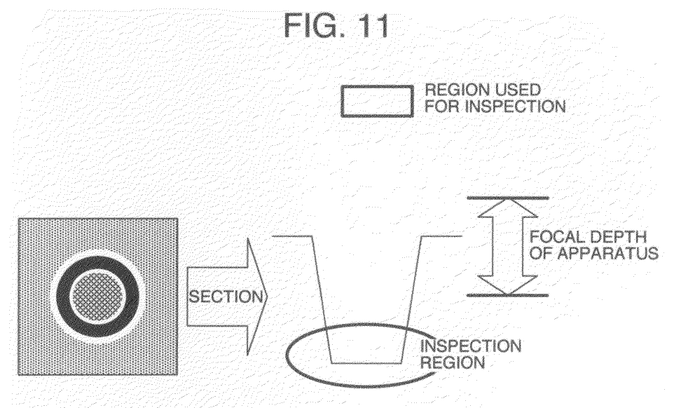

Moreover, when a bottom side part (or uppermost part) of a wafer is to be measured in case where the height of a pattern to be measured and inspected exceeds a focal depth of the apparatus (a focused range in the height direction), the bottom side part of the pattern which is the essential inspection region is sometimes defocused by focusing on the surface layer (or lowermost layer) of the pattern. FIG. 11 is a diagram for explaining the principle thereof. In the case of an example shown in FIG. 11, the depth from the surface to the bottom of the pattern (contact hole) is deeper than the focal depth of SEM. In the general automatic focus correction (AFC), a focal position having the maximum focus estimation value in the scanning region (field of view: FOV) of the electron beam is judged to be a focused position and a position having partially different height such as the bottom of hole is set to be defocused. (When the depth of pattern is deeper than the focal depth of the apparatus or when focusing is performed on the surface of pattern, focusing is not performed on the bottom side part of pattern.)

It is desirable that focusing is performed on the whole image essentially, although it is most important that focusing is performed on part to be measured and inspected. As a method of avoiding such problem, the following method is considered. When measurement of pattern is performed, specific one or plural regions of interest of the image are limited and edge is detected in the limited range.

The selective region information is utilized to perform the picture quality judgment. The region is considered to be square (FIG. 12C) or radial circle (FIG. 12D). As an example of the region used for the image estimation, the following is considered. First, the whole of the image gotten in measurement and inspection is considered to be an object for image estimation (FIG. 12A). In addition, the case where the region to be used for measurement and inspection is an object for picture quality estimation selectively is considered. In this case, the position constituting the standard of measurement for the dimensions of pattern is selectively used for the picture quality estimation. In the example of FIG. 12C, since only two regions of interest (ROI) are to be measured, the parts are to be subjected to the picture quality estimation selectively. Moreover, when an object to be measured is a contact hole, there is a case where a diameter of the hole (or a radius of the hole) is measured in the radial direction from the center of the hole and accordingly as shown in FIG. 12D the region in which the edge part of the hole is expressed is set to a picture quality estimation region selectively.

Furthermore, the pattern formed through predetermined semiconductor process has a shape changing depending on its material, manufacturing apparatus, manufacturing process and manufacturing conditions. Scattering in width or shape of pattern (hereinafter referred to as process variation) can be permitted when it falls within a predetermined range determined at the design stage or a range in which performance of semiconductors is not affected.

However, since the image estimation value is affected by occurrence of the process variation, it is desirable that management is made to discriminate between influence by the process variation and defocusing. The following method is proposed as an example of the discrimination method between the process variation and the defocusing.

First, a method of using edge amount (peripheral length) information of the pattern of the reference image and the inspection image is considered. Second, a method of using signal amount information of the reference image and the inspection image is considered.

The first method is now described by taking the case where the contact hole is to be measured as an example.

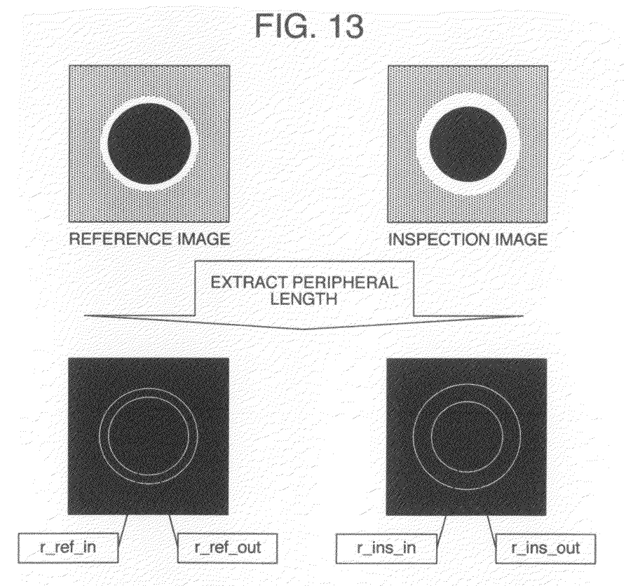

FIG. 13 is a diagram explaining an example of the method of judging whether there is the process variation or not on the basis of detection of edge of a contact hole.

First, an existing edge detection method is applied to each of the reference image and the inspection image to detect inner and outer peripheries thereof. Next, reference values of peripheral lengths thereof are calculated in accordance with the following expressions. When there are a plurality of patterns, this calculation method is applied to each of the plurality of patterns.

Ratio of Inner Peripheral Lengths:

R_in=r_ins_in/r_ref_in (1)

Ratio of Outer Peripheral Lengths:

R_out=r_ins_out/r_ref_out (2)

Ratio of Inner and Outer Peripheries:

R_io=r_ins_io/r_ref_I/O (3)

Ratio of Peripheral Lengths:

R_total=r_ins_total/r_ref_total (4)

where

r_ins_in: inner peripheral length of inspection image

r_ins_out: outer peripheral length of inspection image

r_ins_io: ratio of inner and outer peripheral lengths of inspection image

r_ins_total: total of inner and outer peripheral lengths of inspection image

r_ref_in: inner peripheral length of reference image

r_ref_out: outer peripheral length of reference image

r_ref_io: ratio of inner and outer peripheral lengths of reference image

r_ref_total: total of inner and outer peripheral lengths of reference image

“r_ins_in” and “r_ins out” may be a radius or diameter of the hole.

((1) The edge of the pattern is detected to calculate inner and outer peripheral lengths. (2)

Calculation is made in accordance with the following expressions.

Peripheral Length of Reference Image:

r_ref=r_ref_in+*r_ref_out

Peripheral Length of Reference Image:

r_ins=r_ins_in+*r_ins_out

It is judged whether there is the process variation or not on the basis of whether any or total value of the following falls within a predetermined range or not:

R_in=r_ins_in/r_ref_in

R_out=r_ins_out/r_ref_out

R_io=r_ins_io/r_ref_io

R_total=r_ins_total/r_ref_total)

The above numerical values can be managed individually or collectively to measure the process variation. For example, when the inner periphery of the contact hole is measured, a numerical value of R_in may be managed mainly. When the process variation is too large, it appears as a defect to reduce performance of a device, although it can be detected by managing the numerical value.

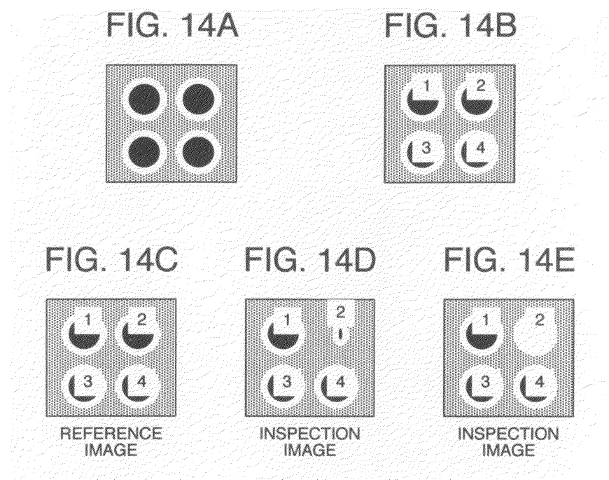

Furthermore, when there are N patterns, numerical values thereof are managed as R_in[N]. There is shown an example of the case where there are four similar hole patterns in an image (FIGS. 14A to 14E). The above numerical values are calculated for each of the reference images and the inspection images and managed as R_in[1˜4], R_out[1˜4], R_io[1˜4] and R_total[1˜4]. When the hole of No. 2 is small as in the inspection image shown in FIG. 14D, the area of the hole for conduction is made small and the device performance is degraded.

It can be detected that the numerical values of R_ins_in[2], R_ins_out[2] and R_ins_total[2] are smaller than other numerical values and formation thereof is insufficient. Moreover, in case of the inspection image (2), the hole of No. 2 is not opened. In this case, conduction with a lower layer is not attained, so that performance of the whole device is affected. In this case, the numerical value of R_ins_in[2] is smaller than others (R_ins_in and R_ref_in) and accordingly it can be detected that the pattern has a defect.

(FIG. 14A shows the case where there are a plurality of patterns, FIG. 14B shows that the plurality of patterns are numbered and the order of number is any, FIG. 14D shows that the hole of No. 2 is small and FIG. 14E shows that the hole of No. 2 is not opened.

(2) R_in, R_out, R_io and R_total are calculated for N (4 in this example) patterns of each of the reference image and the inspection image.

(3) In this example, it can be understood from the numerical value that the shape of the second pattern of the inspection image is improper.)

When the pattern to be measured is a line pattern, it is difficult to apply only judgment using the peripheral length. Accordingly, the second “method of utilizing the signal amount information” is applied.

The existing edge detection method or binarization method is used for each of the reference image and the inspection image to calculate the number of pixels at part where right and left signal amounts are strong.

Thereafter, the right and left signal amounts are calculated by the following expressions. When there are a plurality of patterns to be measured, the calculation method is applied to each of the plurality of patterns.

Signal Ratio of Left Edge:

S_left=s_ins_{—}1/s_ref_{—}1 (5)

Signal Ratio of Right Edge:

S_right=s_ins_r/s_ref_r (6)

Ratio of Comparison Values of Signal Ratios of Right and Left Edges of Inspection Image and Reference Image:

S_lr=s_ins_lr/s_ref_lr (7)

Ratio of Total Signal Amounts of Inspection Image and Reference Image:

S_total=s_ins_total/s_ref_total (8)

where

s_ins_l: signal amount on left side of inspection image

s_ins_r: signal amount of right edge of inspection image

s_ins_lr: ratio of signal amounts of right and left edges of inspection image

s_ins_total: total of signal amounts of right and left edges of inspection image

s_ref_l: signal amount of left edge of reference image

s_ref_r: signal amount of right edge of reference image

s_ref_lr: ratio of signal amounts of right and left edges of reference image

s_ref_total: total of signal amounts of right and left edges of reference image

When there are N patterns in the same manner as the example of the above-mentioned hole pattern, numerical values thereof are managed as R_in[N]. The plurality of patterns are not necessarily required to have the same shape and the patterns may be the same shape in the reference image and the inspection image. The reference image described here is not necessarily required to be an image gotten by the apparatus and may be design data.

((1) Edge detection of pattern is performed to extract a region where signals on right and left lines are strong.

(2) Calculation is made in accordance with the following expressions:

Signal Amount of Reference Image:

s_ref=s_ref_l+*s_ref_r

Signal Amount of Reference Image:

s_ins=s_ins_l+*s_ins_r

and

it is judged whether there is the process variation or not on the basis of any of the following or whether a statistical value is within a predetermined range or not.

S_left=s_ins_l/s_ref_l

S_right=s_ins_r/s_ref_r

S_lr=s_ins_lr/s_ref_lr

S_total=s_ins_total/s_ref_total)

In order to discriminate between the process variation and the defocusing, information gotten by the above first and second methods is utilized.

An example where the edge amount in the image is applied to the picture estimation is described. The edge amount of the image is defined as follows:

Ratio of Edge Amounts of Inner Peripheries:

E_in =e_ins_in/e_ref_in (9)

Ratio of Edge Amounts of Outer Peripheries:

E_out=e_ins_out/e_ref_out (10)

Ratio of Edge Amounts of Inner and Outer Peripheries:

E_io=e_ins_io/e_ref_io (11)

Ratio of Edge Amounts:

E_total=e_ins_total/e_ref_total (12)

where

e_ins_in: edge amount in vicinity of inner periphery of inspection image

e_ins_out: edge amount in vicinity of outer periphery of inspection image

e_ins_io: ratio of edge amounts in vicinity of inner periphery and in vicinity of outer periphery of inspection image

e_ins_total: total of edge amounts in vicinity of inner periphery and in vicinity of outer periphery of inspection image

e_ref_in: edge amount in vicinity of inner periphery of reference image

e_ref_out: edge amount in vicinity of outer periphery of reference image

e_ref_io: ratio of edge amounts in vicinity of inner periphery and in vicinity of outer periphery of reference image

e_ref_total: total of edge amounts in vicinity of inner periphery and in vicinity of outer periphery of reference image

In the above processing, an estimation value of the whole image is calculated before processing (step (6) of FIG. 9) such as measurement, for example, and when there is any problem, a warning message is displayed in GUI to urge the user to take measures or focusing can be made automatically. When the estimation value is calculated after the measurement (step (5)′ of FIG. 9), the result of the measurement can be utilized.

When only the region of interest is limited as shown in FIGS. 12C and 12D, only the range of ±20% of the edge position detected in the measurement can be defined as the estimation value calculation region.

Furthermore, both of information of the measurement result and the defocusing may be used to estimate the result of measurement and inspection and perform subsequent adjustment of apparatus conditions.

There is a possibility that the obtained measurement result is gotten in circumstances (a) to (d) as described below:

(a) The measurement result is normal and focusing is satisfactory.
(b) The measurement result is normal but focusing is deviated or unsatisfactory.
(c) The measurement result is abnormal and focusing is unsatisfactory or deviated.
(d) The measurement result is abnormal but focusing is satisfactory.

In the case of (a) among the above four examples, there is no problem specifically and it can be judged that the measurement result is highly reliable. Similarly even in the case of (d), it is considered that the object to be measured has any problem, although in the cases of (b) and (c), there is a possibility that the measurement results are not necessarily correct.

In these cases, the problematic pattern is judged by mistake to be normal or the normal pattern is judged to be abnormal, so that the subsequent operation efficiency is reduced to cause a problem. Accordingly, in cases of (b) and (c), it is preferable that the user is warned that focusing is deviated so that the user is urged to make re-measurement later or processing is repeated from automatic focusing.

Moreover, there is known a phenomenon that imaging by an electron microscope is affected by disturbance of electron beam caused by hardware in a point for supporting a wafer or in the vicinity of arm for carrying the wafer or in an end portion of the wafer and the image quality is disturbed.

In the method proposed below, the obtained measurement results of defocusing are classified for each of a plurality of predetermined regions of a wafer (for each chip or for each shot unit of an optical exposure apparatus or for any region unit) and defocusing information caused by the sample and defocusing information caused by the apparatus (SEM) are displayed and managed together, so that technical effects as described below can be attained.

Since defocusing caused by the hardware and defocusing caused by the wafer (except the defocusing caused by the hardware) can be managed separately, the primary factor for disturbance of the image quality can be studied promptly. The “defocusing caused by the hardware” means, for example, defocusing caused by magnetizing pin for fixing the wafer and changing the magnetic field in this part or defocusing caused by abnormality occurring in various components disposed in the vicinity of the wafer such as retarding voltage cable. Such information is stored in a storage medium of SEM and used for management of the apparatus.

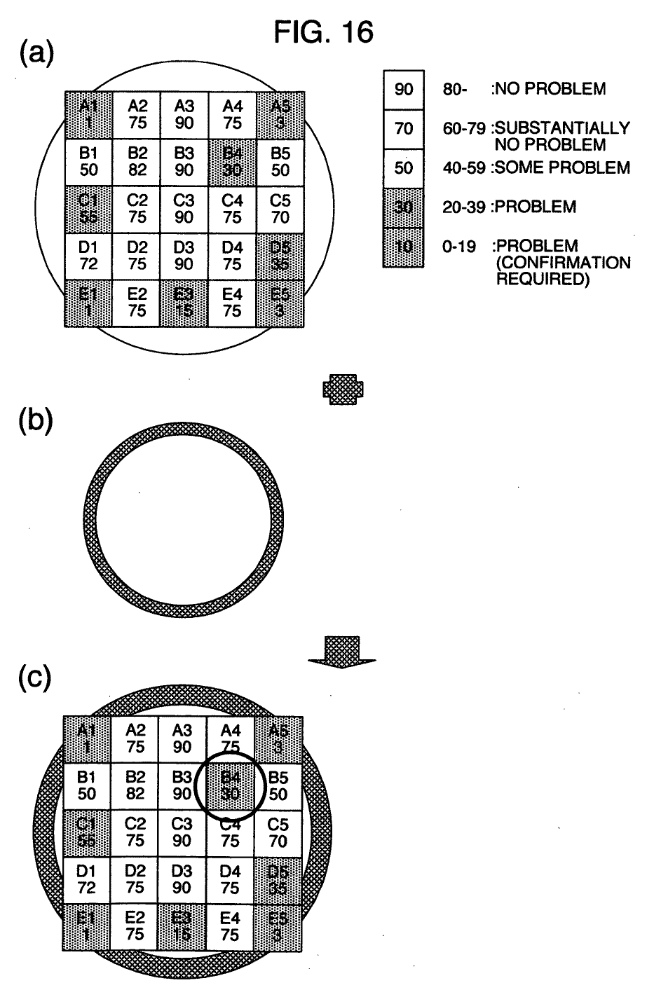

Moreover, particularly, with regard to the “defocusing caused by hardware”, measurement is performed for the same wafer every day, for example, so that information to the effect that there is a possibility that hardware is magnetized from certain time can be monitored. As shown in FIG. 16(a), estimation values for the same pattern are calculated in a plurality of chips in a wafer and displayed in a map manner. The estimation values are normalized in the range of 0 to 100 and classified into five levels as shown below, for example, to be displayed in colors. The map is named a “focus estimation value map”. The focus estimation value is the estimation result at the time that “100” is defined to be in a perfectly focused state and is synonymous with the coincidence degree of the reference image and the inspection image. In this example, the estimation results for each chip are classified into 5 as described below and the classifications are displayed in a discrimination manner.

Group 1: 0-19 (problem (detailed investigation required))

Group 2: 20-39 (problem)

Group 3: 40-59 (some problem)

Group 4: 60-79 (substantially no problem)

Group 5: 80-100 (no problem)

The estimation results may be expressed by any representative value in a plurality of estimation values gotten for each chip or may be expressed by an average value or a statistical value of the estimation values. Next, with respect to the part where there is a high possibility that defocusing occurs in hardware, the map is prepared similarly as shown in FIG. 16(b). This map may be arranged in conformity with a shape of the wafer or arranged containing the stage. The map is named a “hardware defocusing map”.

The two maps are superposed on each other and part where there is no problem in hardware and defocusing occurs is considered to be the defocusing caused by the wafer or the focusing method.

The above data is obtained for a plurality of kinds of wafers and when defocusing occurs in the same place still, it is presumed to be caused by hardware and the “hardware defocusing map” is corrected. Furthermore, when the defocusing occurs in a plurality of wafers or only a certain wafer in a specific process, influence by a local charging or electrification phenomenon caused by wafer can be presumed.

As described above, utilization of the defocusing map can warn the user of part where the defocusing occurs and urge the user not to use the part for measurement or can specify a place or process in which the defocusing is easy to occur (the local electrification phenomenon of the cause is easy to occur).

((a) A map of calculation results of defocusing in each chip in a wafer is prepared and

(b) a map of parts where there is a high possibility that the defocusing caused by hardware occurs is prepared.

It is anticipated that defocusing caused by wafer occurs in part where there is no defocusing in hardware.)

Moreover, by combining the following information, improvement of the measurement accuracy based on specificity of wrong measurement can be expected.

(1) Estimation value information (information gotten in the embodiment)
(2) Measurement result information (information concerning the measurement result gotten by SEM).
(3) Defect information (information gotten by defect inspection apparatus)

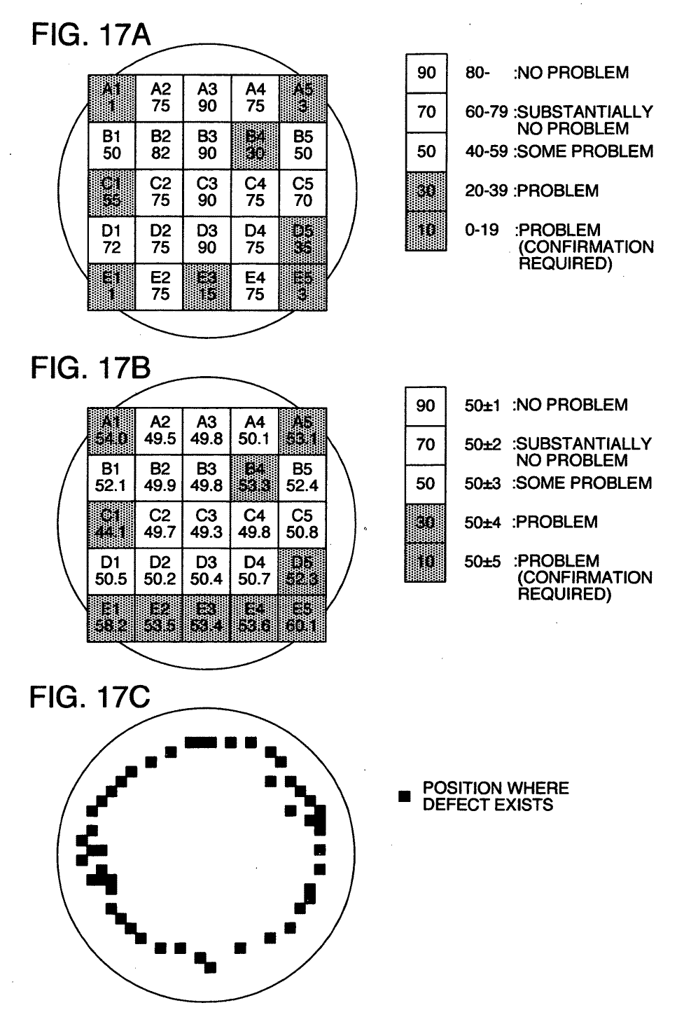

FIGS. 17A, 17B and 17C are diagrams for explaining display examples of the above (1), (2) and (3). In the embodiment, information of (1), (2) and (3) is divided to be displayed by way of example, although the present invention is not limited thereto and the information may be displayed in a superposed manner, for example. In this case, the region judged to be “problem” is displayed in a discrimination manner from other regions and the region judged to be “problem” may be displayed so as to indicate that the problem resides in all or only one or two of the information of the above (1), (2) and (3).

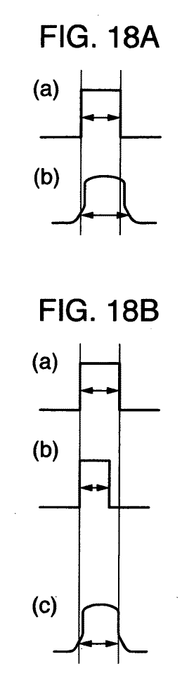

First, an example of a combination of the above (1) and (2) is shown. For example, the case where a line width of a convex line pattern is measured is considered. FIGS. 18A and 18B show shapes of line profiles obtained in case (a) where beam is focused and case (b) where beam is defocused.

When measurement is performed on the basis of the same standard in the above cases (for example, when the upper part and the bottom part of the pattern are measured at 70% from above), the measurement results are different because of change in shape of the pattern due to defocusing. In this case, the measurement result is larger than actual object due to defocusing (case 1). Further, even in case (c) where the pattern is narrower than a design value and is to be detected as abnormal pattern originally, the case where the pattern is measured to be larger in appearance due to defocusing and is judged to be a normal value (case 2) is also supposed. When a concave pattern is measured, an opposite phenomenon occurs.

In order to grasp wrong detection based on such phenomena, the formation situation of pattern is judged together with the information of the above (1) and (2). When the measurement result of (2) is abnormal even if the measurement result of (1) is normal, it is judged that the measurement has problem and the user is urged to perform re-measurement.

As described above, whether both of (1) and (2) are abnormal or whether any of (1) and (2) is abnormal is displayed or managed as information for each predetermined area, so that improvement of the measurement accuracy based on specificity of factor for wrong measurement can be attained.

([Case 1] When measurement is performed on the basis of the same standard, the measurement value is different in case of focusing (a) and in case of defocusing (b).)

([Case 2] The pattern to be detected as abnormal pattern originally and narrower than a permissible value is judged to be thick in appearance due to defocusing and is measured to be normal in error.

a) normal pattern

b) pattern having measurement value smaller than the permissible value in design→it is judged to be abnormal originally

c) measurement value is increased in appearance since the pattern is defocused and it is measured to be normal pattern in error.)

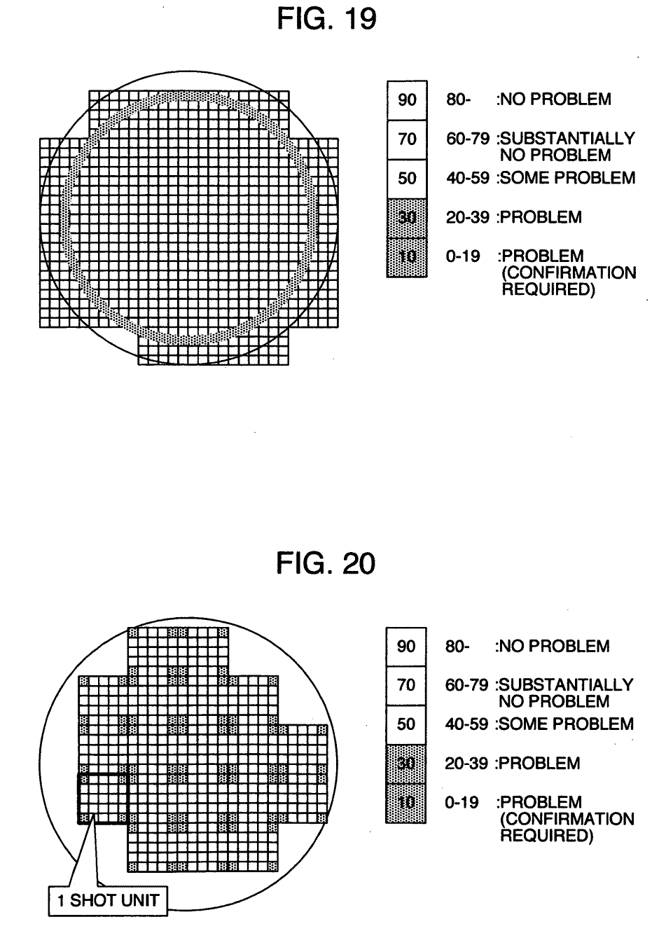

Next, an example of combination of (1), (2) and (3) is described. FIG. 19 shows a display example of a wafer map and is a diagram explaining the display example where estimation values in regions near the edge part of a wafer are low.

((1) Map for calculation results of defocusing in each chip in wafer. Example) Estimation value in only certain part of wafer is low.)

When the estimation value near the peripheral region of the wafer is low, the possibility that the estimation value is varied due to foreign matter is also supposed. When the foreign matter is a cause, its situation can be estimated if it can be confirmed together with “(1) estimation value information and “(3) defect information”. That is, in the region where there is a defect, the estimation value calculated by comparison with the reference image having no defect has a tendency to be reduced and the result of the defect inspection has also a tendency to get worse in the meaning that there is a defect. In this manner, judgment is made together with information related to the foreign matter and the defect, so that the factor for variation of the measurement result can be specified easily. In this case, image may be displayed together therewith.

When there is a defect, it is supposed that the measurement result by the apparatus is also adversely affected, although even if there is a defect in the picture, the measurement result is not sometimes affected directly when the defect is not positioned in a measurement part. In such a situation, by confirming it together with the “(2) measurement information”, it can be specified easily. Moreover, since an electric field is disturbed in the vicinity of the wafer, defocusing occurs easily. The measurement result is collated with the “(3) defect information” and when the estimation value is low since there is no defect, there is a high possibility that it is caused by defocusing.

As described above, the information of (1) to (3) can be managed together therewith, so that it can be judged whether wrongness of the measurement result is caused by defect or defocusing.

Furthermore, when the numerical values of the “(2) estimation value information”, for example, are greatly varied in the center and the peripheral part of a region unit exposed by an optical exposure apparatus, there is a possibility of the process variation caused by mask used in the optical exposure apparatus. FIG. 20 is a diagram explaining an example in which equivalent dispersion result of the estimation value is recognized in a shot unit of the optical exposure apparatus. According to this displayed picture, the process variation caused by the mask or the optical exposure apparatus can be specified easily.

((1) Map of calculation results of defocusing in each chip of wafer. Example) Estimation value is made small in only the vicinity of the shot unit.)

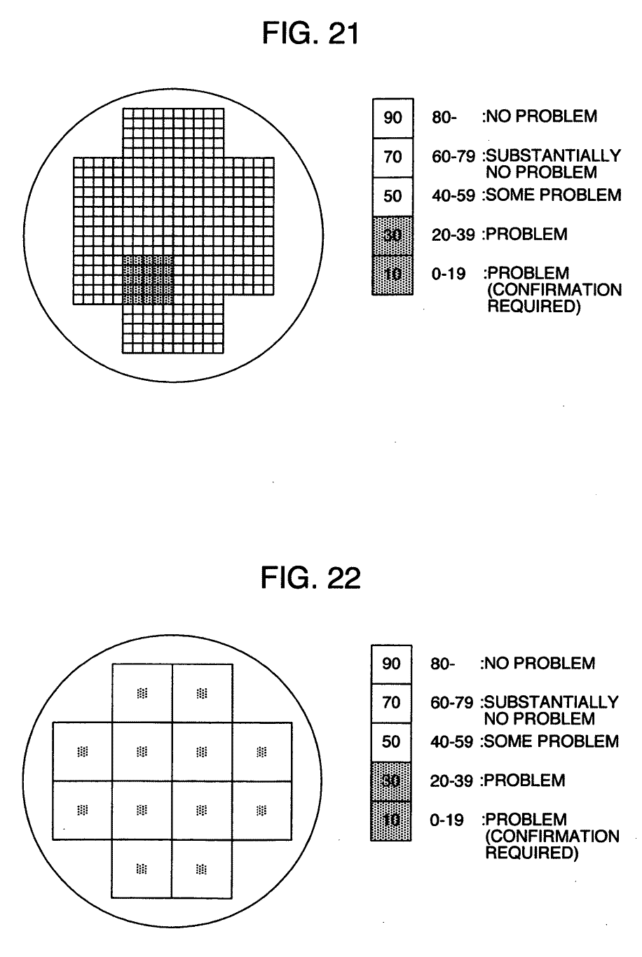

Moreover, when the process variation occurs in only a part or the vicinity of the wafer, a problem of the process variation due to local electrification or exposure is supposed. FIG. 21 is a diagram explaining a display example of a wafer map of wafer in which the estimation value information is varied locally.

((1) Map of calculation results of defocusing in each chip of wafer. Example) Estimation value is small in only a certain part of a wafer.)

According to such display, it can be anticipated that the estimation value is varied due to electrification generated locally. Moreover, when only the estimation value at the same part in a chip unit is low, the factor of variation of the estimation value caused by pattern structure at this part (for example, local electrification) is considered. FIG. 22 is a diagram explaining a display example of a wafer map when the estimation values at the same parts of a plurality of chips formed in a wafer is low.

((1) Map of calculation results of defocusing in each chip of wafer. Example) Estimation value in only a certain position of a chip is low.)

In addition, when the numerical values in the whole wafer are low, there is considered a possibility that the process variation exists extensively due to electrification on the whole surface of the wafer or exposure problem or setting of recipe is not proper.

The phenomenon of a certain degree can be analogized from a distribution situation of the estimation values on the whole wafer and its cause can be specified.

It should be further understood by those skilled in the art that although the foregoing description has been made on embodiments of the invention, the invention is not limited thereto and various changes and modifications may be made without departing from the spirit of the invention and the scope of the appended claims.

1. A sample inspection, measuring method of performing inspection or measurement of a pattern on a sample on the basis of electrons gotten by scanning the sample with a focused electron beam, comprising:
forming an image for measuring the pattern or an image for making positioning for the measurement by scanning the sample with the focused electron beam, comparing an estimation value of the image with an image estimation value of a previously gotten reference image and performing focusing of the electron beam again when it is judged that the formed image does not satisfy a predetermined condition by the comparison with the reference image.

2. A sample inspection, measuring method according to claim 1, wherein
the image for measuring the pattern or the image for making positioning for the measurement is formed on the basis of electrons detected by scanning the sample with the electron beam after focusing of the electron beam is performed.

3. A sample inspection, measuring method according to claim 1, comprising:
with regard to a cause to generate difference between the estimation value of the reference image and the estimation value of inspection image, discriminating between the cause resulting from variation in shape of the pattern itself to be measured and other causes resulting from the difference occurring since the focusing is insufficient to be expressed numerically and performing the focusing of the electron beam again when the predetermined condition is not satisfied.

4. A sample inspection, measuring method according to claim 1, wherein
with regard to a cause to generate difference between the estimation value of the reference image and the estimation value of inspection image, in order to discriminate between the cause resulting from variation in shape of the pattern itself to be measured and other causes resulting from the difference occurring since the focusing is insufficient to be expressed numerically, the whole of the image or only any region is used to perform numerical expression.

5. A charged particle beam apparatus including an objective lens for focusing a charged particle beam emitted from a charged particle source on a sample to irradiate the sample with the beam and a controller for controlling the objective lens, wherein
the controller forms an image for measuring a pattern or an image for making positioning for measurement by scanning the sample with the electron beam focused by the objective lens and compares an estimation value of the image with an image estimation value of a previously gotten reference image, so that focusing of the electron beam is performed again when it is judged that the formed image does not satisfy a predetermined condition by the comparison with the reference image.

6. A program for causing a computer connected to a scanning electron microscope for forming an image on the basis of electrons gotten by scanning a sample with an electron beam focused by an objective lens to adjust a lens condition of the objective lens, wherein
the program makes the computer form an image for measuring a pattern or an image for making positioning for measurement by scanning the sample with the electron beam focused by the objective lens and compare an estimation value of the image with an image estimation value of a previously gotten reference image, so that focusing of the electron beam is performed again when it is judged that the formed image does not satisfy a predetermined condition by the comparison with the reference image.
